(19) United States
(12) Patent Application Publication
(10) Pub. No.: US 2026/0337504 A1
(43) Pub. Date: Oct. 29, 2026

(54) SYNGAS PRODUCTION DEVICE USING NANO-SCALE PULVERIZATION OF COAL POWDER

(71) Applicant: Tae Youl LEE, Seoul (KR)

(72) Inventor: Tae Youl LEE, Seoul (KR)

(21) Appl. No.: 19/419,060

(22) Filed: Dec. 14, 2025

Related U.S. Application Data
(63) Continuation of application No. PCT/KR2024/018746, filed on Nov. 25, 2024.

(30) Foreign Application Priority Data
Oct. 8, 2024 (KR) 10-2024-0137058

(51) Int. Cl. C10J 3/48; C10J 3/46; C10J 3/52; C10J 3/72

(52) U.S. Cl. CPC C10J 3/487; C10J 3/466; C10J 3/526; C10J 3/721; C10J 3/723; C10J 2300/093; C10J 2300/0959; C10J 2300/1238

(57) ABSTRACT

A syngas production device using nano-scale pulverization of coal powder includes a pulverizer configured to pulverize coal powder fed from a hopper to an ultrafine size, a plurality of injectors configured to pneumatically convey and inject the ultrafine coal powder into a cylindrical header within a vortex chamber, a distributor configured to evenly feed the ultrafine coal powder to the injectors, vortex fans configured to generate a swirling airflow within the vortex chamber, thereby enabling nano-scale pulverization of the ultrafine coal powder, a vacuum chamber, a plurality of spiral branch pipes configured to induce an implosion of the resulting nano-scale coal powder, a plasma generator configured to form ions and radicals from the nano-scale coal powder and gas within the vacuum chamber to generate a plasma state, and to convert the resulting plasma-state gas into syngas, and a gas collector configured to collect and store the syngas.

### CROSS-REFERENCE TO RELATED APPLICATIONS

This application is a Continuation of International Application No. PCT/KR2024/018746 filed Nov. 25, 2024, which claim priority from Korean Application No. 10-2024-0137058 filed Oct. 8, 2024. The aforementioned applications are incorporated herein by reference in their entireties.

### TECHNICAL FIELD

The present disclosure relates to a device configured to produce syngas primarily composed of CO and H₂ by gasifying coal powder as a feedstock. More particularly, the present disclosure relates to a syngas production device using nano-scale pulverization of coal powder, in which the coal powder is pulverized to an ultrafine size, imploded, and then gasified in a plasma state through plasma gasification to produce syngas.

### RELATED ART

In general, coal has more abundant reserves than fossil fuels such as oil and natural gas. However, the use of coal through direct combustion results in large amounts of carbon dioxide, which contributes to global warming, as well as sox and NOx, which are environmental pollutants.

Such coal is thermally decomposed at high temperatures and gasified, and the resulting gas then undergoes dust collection, purification, and CO₂ removal processes to produce syngas (H₂ and CO) primarily composed of carbon monoxide, hydrogen, and carbon dioxide. Active research is underway to convert syngas into synthetic natural gas (SNG), primarily composed of methane, through methanation using the resulting syngas as the reactant.

The main reaction equations and reaction heat for producing SNG, primarily composed of methane, using syngas are as follows.

CO+2H₂→CH₄+H₂O (heat of reaction: 206 KJ/mol)

CO₂+4H₂→CH₄+2H₂O (heat of reaction: 165 KJ/mol)

In the meantime, syngas (or synthesis gas) is a mixed gas of hydrogen and carbon monoxide used as a feedstock for chemical reactions.

Such syngas can serve as a feedstock for various chemical products, including ammonia, dimethyl ether, and methanol, or as energy sources for electricity generation and the like, as shown in FIG. 1.

In addition, syngas can be produced not only using petroleum-based hydrocarbon compounds such as coal and naphtha, but also using biomass and carbon dioxide.

Recently, with emerging technologies for producing hydrogen from syngas, the applications of syngas have been diversifying from feedstocks for existing chemical products to synthetic fuels used as energy sources.

Coal is converted into syngas through a gasification facility, where various reactions such as partial oxidation, steam reforming, carbon dioxide reforming, hydrogen reforming, and water-gas shift reactions occur within the gasifier to produce syngas. After removing impurities through purification processes, the resulting syngas is subsequently used for chemical synthesis or fed as a fuel.

In existing syngas production processes, not only is carbon dioxide emitted during the process in which high temperatures are applied for gas separation and purification, but soot (carbon) is also generated as a byproduct of reforming reactions that occur at high temperatures.

In the meantime, Patent Document 1 discloses a “Gasifier System and Method for Producing Syngas Therefrom”, in which coal powder is fed into a gasifier using biogas and undergoes gasification within the gasifier to produce syngas.

However, this patent has limitations in that the reaction rate is substantially slow because biogas, which is primarily composed of methane (CH₄) and carbon dioxide (CO₂), is used to transfer coal powder, and that the amount of carbon dioxide, which is the primary contributor to the global greenhouse effect among the components of syngas, increases.

Furthermore, this method involves incompletely combusting coal powder through reactions with sub-stoichiometric amounts of oxygen and steam under high-temperature and high-pressure conditions to produce syngas, which is primarily composed of carbon monoxide (CO) and hydrogen (H₂). As a result, a large amount of slag derived from inorganic components is generated, which is problematic.

The background art or related art described herein is information that the inventor of the present disclosure has possessed or acquired in the course of deriving and completing the present disclosure, and is provided solely to aid in understanding the technical significance of the present disclosure and to be useful for searches and examination of the related art. It should be noted that this does not mean that such technology was commonly known or widely used in the technical field to which the present disclosure pertains before the filing of the present application.

### SUMMARY

Accordingly, the inventor of the present disclosure, while comprehensively considering the matters described above, sought to overcome the technical limitations and problems of existing devices and technologies for producing syngas, which is primarily composed of CO and H₂, from coal powder as a feedstock. Based on this idea, the inventor made sustained and intensive efforts to develop a syngas production device having a novel structure and using nano-scale pulverization of coal powder, in which the coal powder is pulverized to an ultrafine size, rapidly rotated to increase its activity, induced to undergo an implosion in which the resulting gas collapses inward toward its center, and then gasified in a plasma state through plasma gasification, thereby enabling production of syngas. As a result of such continuous research, the present disclosure was ultimately devised.

Therefore, the technical problem and objective that the present disclosure seeks to address is to provide a syngas production device using nano-scale pulverization of coal powder, in which the coal powder is pulverized to an ultrafine size, imploded, and then gasified in a plasma state through plasma gasification, thereby enabling production of syngas.

In this case, technical problems and objectives that the present disclosure seeks to address are not limited to the aforementioned technical problem and objective, and other technical problems and objectives not mentioned herein will be clearly understood by those skilled in the technical field to which the present disclosure pertains, from the following description.

The specific means according to an aspect of the present disclosure for effectively achieving a particular technical objective while embodying a new conception to address the technical problems of the present disclosure, as described above, discloses a syngas production device using nano-scale pulverization of coal powder, which is characterized by employing: a hopper configured to store and feed coal powder; a pulverizer configured to pulverize the coal powder, fed from the hopper, to an ultrafine size; a plurality of injectors configured to pneumatically convey the resulting ultrafine coal powder, which has been pulverized to the ultrafine size within the pulverizer, and inject the same into a cylindrical header within a vortex chamber; a distributor installed on a pipeline between the pulverizer and the injectors, and configured to evenly feed the ultrafine coal powder to the respective injectors; a pair of vortex fans configured to be rotated by a motor and generate a swirling airflow within the vortex chamber, thereby enabling nano-scale pulverization of the ultrafine coal powder through collisions and repeated friction at a point where centrifugal and centripetal forces generated by a vortex-induced airflow are in equilibrium; a vacuum chamber vertically separated from the vortex chamber by a partition wall; a plurality of spiral branch pipes, each having a first end being fixedly connected in communication from outside the header and a second end (opposite to the first end) being connected in communication with an interior of the vacuum chamber, thereby inducing an implosion of the resulting nano-scale coal powder to be fed into the vacuum chamber; a plasma generator configured to form ions and radicals from the nano-scale coal powder and gas within the vacuum chamber to generate a plasma state, and to convert the resulting plasma-state gas into syngas through plasma gasification; and a gas collector configured to collect and store the syngas within the vacuum chamber.

Accordingly, in the present disclosure, the coal powder is pulverized to the ultrafine size, rapidly rotated to increase its activity, induced to undergo an implosion in which the resulting gas collapses inward toward its center, and then gasified in a plasma state through plasma gasification, thereby enabling stable production of syngas, which is primarily composed of CO and H₂.

In addition, a preferred aspect of the present disclosure may further include an electromagnet configured to magnetically separate and collect pyrite (FeS₂) within the vortex chamber, thereby removing sulfur compound components and enabling purification.

In addition, a preferred aspect of the present disclosure may further include an oxygen supplier configured to supply oxygen into the vacuum chamber to promote plasma gasification and increase the entropy of radicals, a heater configured to activate atomic or ionic energy within the vacuum chamber through temperature control, and a cooler, thereby enabling maximization of syngas production efficiency relative to the feed rate of the coal powder.

In addition, in a preferred aspect of the present disclosure, the pair of vortex fans may be rotated in opposite directions, and each vortex fan may be mounted in such a configuration that two impellers overlap on a motor shaft of the motor and may be installed within the vortex chamber at an oblique angle in a range of 30 to 60 degrees relative to a horizontal plane, thereby automatically accelerating or decelerating the kinetic velocity of the ultrafine coal powder molecules, and enabling more effective nano-scale pulverization.

In addition, in a preferred aspect of the present disclosure, the branch pipes may be arranged all around the header, and each branch pipe may be formed as a conical spiral pipe having an inner diameter that gradually decreases from the first end adjacent to the header toward the second end, thereby further facilitating induction of the implosion of the nano-scale coal powder to be fed into the vacuum chamber.

According to an embodiment that implements the technical idea on which the unique solution is based in order to solve the technical problem of the present disclosure, coal powder is pulverized to an ultrafine size, rapidly rotated to increase its activity, induced to undergo an implosion in which the resulting gas collapses inward toward its center, and then gasified in a plasma state through plasma gasification, thereby enabling stable production of syngas, which is primarily composed of CO and H₂.

In other words, the resulting ultrafine coal powder and air within a vortex chamber are injected in a swirling flow into branch pipes, thereby enabling stable nano-scale pulverization of the ultrafine coal powder and feeding the resulting nano-scale coal powder into a vacuum chamber. In addition, the nano-scale coal powder and gas molecules containing oxygen are converted into syngas through collisions with high-energy electrons generated from the plasma within the vacuum chamber, thereby enabling maximization of syngas production efficiency relative to the feed rate of the coal powder.

Furthermore, the present disclosure is not only environmentally friendly because both carbon dioxide emissions and hydrogen consumption are minimized, but also reduces manufacturing costs, thereby enabling economical and efficient production of syngas.

In this case, effects of the present disclosure are not limited to the aforementioned effects, and other effects not mentioned herein will be clearly understood by those skilled in the technical field to which the present disclosure pertains, from the description of the appended claims.

### BRIEF DESCRIPTION OF THE DRAWINGS

FIG. 1 is a block diagram schematically illustrating a syngas production process using coal powder.

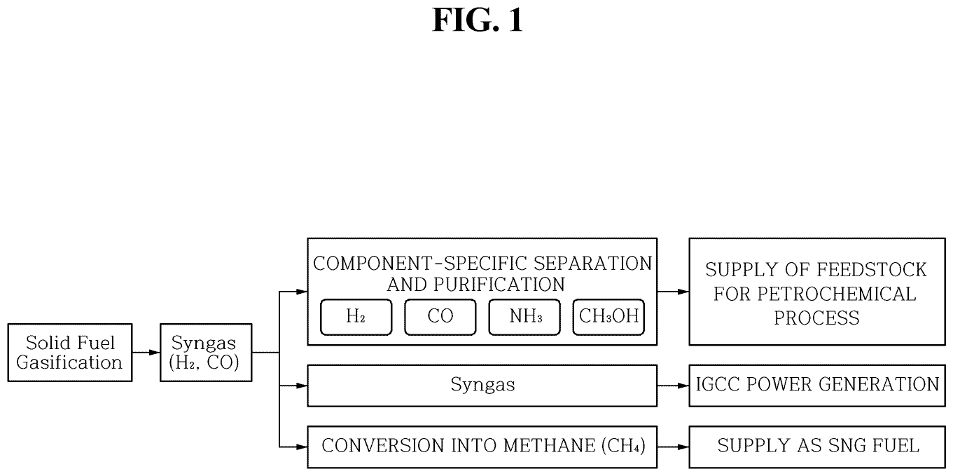

FIG. 2 is a partial cross-sectional view schematically illustrating a syngas production device using nano-scale pulverization of coal powder according to an embodiment of the present disclosure.

FIG. 3 is a perspective view illustrating a branch pipe constituting a syngas production device using nano-scale pulverization of coal powder according to an embodiment of the present disclosure.

FIG. 4 is a view provided to assist in understanding the operating state of a syngas production device using nano-scale pulverization of coal powder according to an embodiment of the present disclosure.

### DETAILED DESCRIPTION

Hereinafter, an embodiment according to the present disclosure will be described in more detail with reference to the accompanying drawings.

Before discussing the details, it is to be noted that the terms described below are defined in consideration of their functions in the present disclosure, and that such terms shall be interpreted in accordance with concepts consistent with the technical idea of the present disclosure and with meanings commonly used or ordinarily recognized in the technical field to which the present disclosure pertains.

In addition, if it is determined that a detailed description of a known function or configuration related to the present disclosure may unnecessarily obscure the gist of the present disclosure, such a detailed description will be omitted.

It is to be noted that the accompanying drawings may be exaggerated or simplified in part for purposes of illustrating the configuration, operation, and operational principles of the technology, as well as for the convenience of understanding and clarity of description, and that the respective components shown in the drawings do not necessarily correspond exactly to their actual sizes or shapes.

In addition, the term “and/or”, as used herein, means a combination of a plurality of related described items or any one of the plurality of related described items. When a part is described as including a component, this means, unless the context clearly indicates otherwise, that the part may include other components in addition to the stated component, rather than excluding other components.

In other words, it should be understood that the terms “comprise”, “include”, “have”, and the like, as used herein, specify the presence of features, numbers, steps, processes, operations, components, parts, or combinations thereof, but do not preclude the possibility of the presence or addition of one or more other features, numbers, steps, processes, operations, components, parts, or combinations thereof.

In the meantime, the terms “part”, “portion”, and “unit”, as used herein, refer to a module serving as a unit or plays a role that performs at least one intended function or a certain operation in a device or system, and may be implemented as means based on hardware, software, or a combination of hardware and software, or as a device, assembly, or the like capable of performing independent operations.

In addition, the terms upper, lower, top, bottom, upper portion, lower portion, upper side, lower side, front or rear, left or right, and the like, as used herein, are used for the convenience of distinguishing relative positions of each component or describing movement directions. For example, in a drawing, the upper and lower sides may be called or referred to as an upper portion and a lower portion, respectively, and the longitudinal and transverse directions may be called or referred to as a front-rear direction and a left-right direction, respectively.

Furthermore, the terms “first”, “second”, and the like, as used herein, may be used to describe various components. In other words, the terms “first”, “second”, and the like may be used merely for distinction of one component from another.

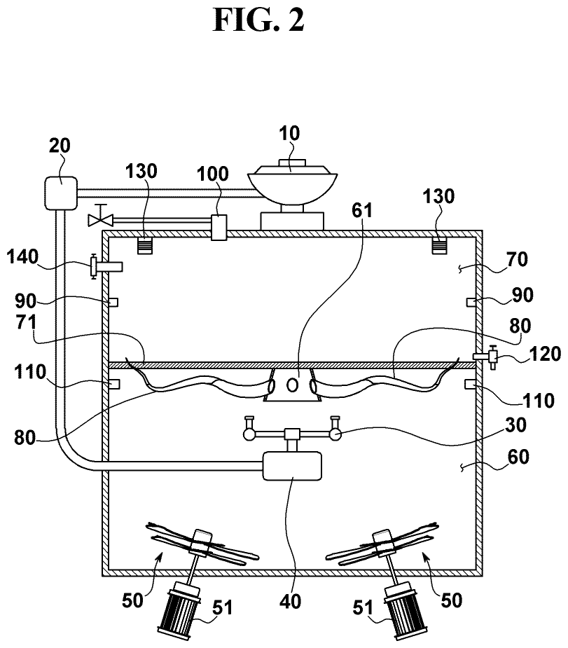

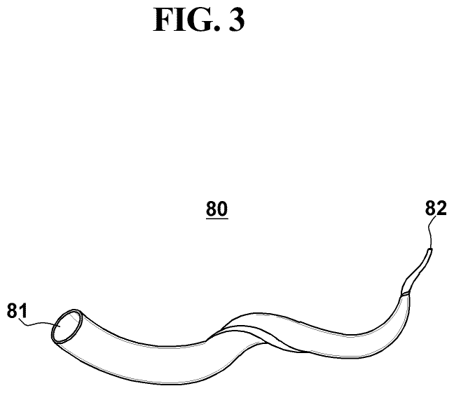

The main elements constituting a syngas production device using nano-scale pulverization of coal powder according to an embodiment of the present disclosure include a hopper 10, a pulverizer 20, an injector 30, a distributor 40, a vortex fan 50, a vortex chamber 60, a vacuum chamber 70, a branch pipe 80, a plasma generator 90, a gas collector 100, an electromagnet 110, an oxygen supplier 120, a heater 130, and a cooler 140, as shown in FIGS. 2 and 3.

The hopper 10 serves to store and feed a predetermined amount of coal powder having a size in the range of 50 to 150 μm.

In this case, the hopper 10 may be formed as a funnel-shaped container that drops and transfers the coal powder into the pulverizer 20 by its own weight.

In addition, the hopper 10 may be provided with an automatic feeder configured to continuously transfer the coal powder into the pulverizer 20 by opening the outlet, as needed.

The pulverizer 20 serves to pulverize the coal powder having a size in the range of 50 to 150 μm, fed from the hopper 10, to an ultrafine size in the range of 20 to 50 μm, and to feed the resulting ultrafine coal powder.

In this case, as the pulverizer 20, an air-jet mill capable of obtaining ultrafine particles through self-grinding using vibrations resulting from high-speed turbulence and high-frequency pressure fluctuations may be selected and applied. In addition, the ultrafine coal powder, which has been pulverized to an ultrafine size, may be evenly and stably fed into the distributor 40, using an electromagnetic vibration feeder or an electromagnetic vibration magnetic feeder.

The injector 30 serves to feed the ultrafine coal powder, which has been pulverized to an ultrafine size within the pulverizer 20 and then fed into the distributor 40, into a cylindrical header 61 within the vortex chamber 60.

In other words, the injectors 30 are installed within the vortex chamber 60, and are connected to the pulverizer 20 through the distributor 40 and a pipeline.

In this case, the injector 30 may be provided as an air-injection device that pneumatically conveys the ultrafine coal powder with compressed air and strongly injects the same into the header 61.

In addition, as the injector 30, a rotary injector allowing an arm, on which nozzles are installed, to rotate by the reaction force generated when the ultrafine coal powder and air are discharged from the nozzles may be selected and applied.

The distributor 40 serves to evenly feed the ultrafine coal powder into the respective injectors 30.

In other words, the distributor 40 is installed on the pipeline between the pulverizer 20 and the injectors 30 to evenly feed the ultrafine coal powder, which is fed from the pulverizer 20, to the respective injectors 30.

The vortex fan 50 serves to generate a swirling airflow within the vortex chamber 60 while being rotated by an electric motor 51.

In addition, the vortex fans 50 are provided as a pair arranged on the left and right sides, and each vortex fan 50 is installed within the vortex chamber 60 at an oblique angle in the range of 30 to 60 degrees relative to a horizontal plane so that airflows intersect.

In other words, the pair of vortex fans 50 is installed to face each other within the vortex chamber 60 so as to enable nano-scale pulverization of the ultrafine coal powder through collisions and repeated friction at a point where centrifugal and centripetal forces generated by a vortex-induced airflow are in equilibrium.

For example, each vortex fan 50, while facing one another, may be rotated in opposite directions at a speed in the range of 200 to 3600 rpm by each electric motor 51, thereby strongly rotating the air within the vortex chamber 60 into a swirling flow.

In addition, each vortex fan 50 may be mounted in such a configuration that two impellers overlap on the motor shaft of each electric motor 51.

The vortex chamber 60 is formed of a refractory and insulating material to generate the vortex of the ultrafine coal powder.

In other words, the vortex chamber 60 is formed such that the air discharged together with the ultrafine coal powder from the injectors 30 can generate a vortex therein.

In addition, the upper portion of the vortex chamber 60 is mounted with the cylindrical header 61 that fixedly connects a plurality of branch pipes 80.

The vacuum chamber 70 is vertically separated from the vortex chamber 60 by a partition wall 71 so as to minimize the influence of impurities under a vacuum pressure below atmospheric pressure and to enable complete and uniform plasma generation.

In addition, the vacuum chamber 70 is formed of a refractory and insulating material on the upper side of the vortex chamber 60 so as to maintain uniform internal temperature distribution, enable precise temperature control to prevent overheating, and optimize thermal efficiency.

In this case, the vacuum chamber 70 may be designed using metal or the like to withstand high vacuum pressure, and may be connected to a vacuum pump configured to remove air and maintain an ultra-high vacuum by lowering the internal pressure.

Multiple branch pipes 80 are arranged all around the header 61 within the vortex chamber 60.

In other words, a first end 81 in the longitudinal direction of each branch pipe 80 is fixedly connected in communication with the interior of the header 61 from outside the header 61, and a second end 82 (opposite to the first end 81) is connected in communication with the interior of the vacuum chamber 70.

In addition, each branch pipe 80 is formed as a conical spiral pipe having an inner diameter that gradually decreases from the first end 81 adjacent to the header 61, into which the nano-scale coal powder is introduced, toward the second end 82 on the outer side, through which the nano-scale coal powder is discharged, to induce the implosion of the nano-scale coal powder to be fed into the vacuum chamber 70.

In addition, the branch pipe 80 is formed of a copper alloy, stainless steel, or the like, such that the inlet has an inner diameter of 100 mm and the outlet has an inner diameter in the range of 1 to 2 mm.

Such branch pipes 80 rapidly rotate the ultrafine coal powder to increase its activity, thereby inducing an implosion in which the resulting gas collapses inward toward its center.

The plasma generator 90 serves to form ions and radicals from the nano-scale coal powder and gas within the vacuum chamber 70 to generate a plasma state, and to convert the resulting plasma-state gas into syngas through plasma gasification.

In this case, as the plasma generator 90, a radio-frequency (RF) plasma generator that applies an alternating current at a frequency of 13.56 MHz to rapidly change the movement direction of electrons, thereby generating a plasma through collisions with neutral particles, may be selected and applied.

For example, when the internal pressure of the vacuum chamber 70 is maintained at about 10 mmHg, the plasma can be generated by simply applying 100 V.

Since plasma gasification by such a plasma generator 90 is performed through a thermochemical process within the vacuum chamber 70 under oxygen-deficient conditions, no combustion caused by oxygen occurs. Accordingly, the coal powder is thermally decomposed into simple molecules and converted into syngas, which is a clean energy source, thereby preventing the emission of pollutants into the atmosphere.

The gas collector 100 serves to draw in, collect, and store the syngas within the vacuum chamber 70.

In other words, the gas collector 100 recovers the high-purity syngas within the vacuum chamber 70, and stores and delivers the recovered syngas.

The syngas within such a gas collector 100 can be used as a feedstock for the production of various synthetic fuels through a post-treatment process such as a methanol synthesis process (for synthetic fibers and chemical products), an F-T synthesis process (for synthetic petroleum), a dimethyl ether (DME) synthesis process (for diesel alternative fuels), or a hydrogen purification process (for fuel cells).

In addition, it is apparent that the syngas within the gas collector 100 can optionally be used directly as a fuel for power generation.

The electromagnet 110 serves to magnetically separate and collect pyrite (FeS₂) within the vortex chamber 60.

The oxygen supplier 120 serves to inject and supply oxygen into the vacuum chamber 70 to promote plasma gasification within the vacuum chamber 70 and increase the entropy of radicals.

The heater 130 serves to increase the temperature within the vacuum chamber 70 to activate atomic or ionic energy.

The cooler 140 serves to lower the temperature within the vacuum chamber 70 to activate atomic or ionic energy.

In this case, as the cooler 140, an argon gas cooling and circulation system may be selected and applied.

In the meantime, the overall configuration and operation of the syngas production device using nano-scale pulverization of coal powder according to an embodiment of the present disclosure may be controlled by a separate controller.

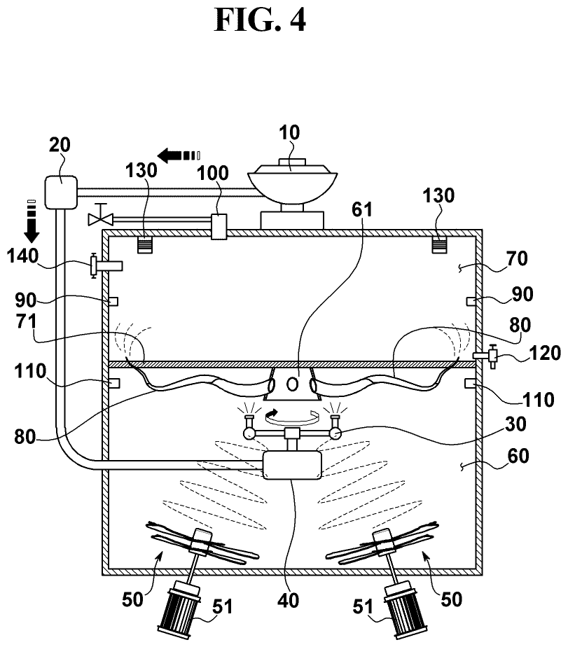

The main actions, operating principles, and functions of the syngas production device using nano-scale pulverization of coal powder according to an embodiment of the present disclosure, configured as described above, will be described below with reference to FIG. 4.

First, the coal powder having a size in the range of 50 to 150 μm, transferred from the hopper 10, is pulverized to an ultrafine size in the range of 20 to 50 μm within the pulverizer 20.

Thereafter, the resulting ultrafine coal powder, which has been pulverized to an ultrafine size in the range of 20 to 50 μm within the pulverizer 20, is pneumatically conveyed by the injectors 30 and injected into the cylindrical header 61 within the vortex chamber 60.

In this case, the ultrafine coal powder and air within the vortex chamber 60 are injected into the header 61 and the branch pipes 80 in a swirling flow by the vortex fans 50, thereby enabling stable nano-scale pulverization of the ultrafine coal powder and feeding the resulting nano-scale coal powder into the vacuum chamber 70.

In this process, the ultrafine coal powder is evenly distributed by the distributor 40 installed on the pipeline connecting the pulverizer 20 and the injectors 30, and then fed into multiple nozzles of the injectors 30. Subsequently, pyrite (FeS₂) floating inside the vortex chamber 60 is magnetically separated and collected by the action of the electromagnet 110.

In addition, due to the structural characteristic that each branch pipe 80 is formed as a conical spiral pipe having an inner diameter that gradually decreases from the header 61, that is, the inside, toward the outside, the ultrafine coal powder is rapidly rotated within the branch pipes 80 to increase its activity, thereby inducing an implosion in which the resulting gas collapses inward toward its center. As a result, the ultrafine coal powder can be fed into the vacuum chamber 70 in a more stable molecularized and nano-scale state.

Then, the nano-scale coal powder within the vacuum chamber 70 is gasified in a plasma state through plasma gasification by the plasma generator 90, and the resulting plasma-state gas is converted into syngas, which is primarily composed of CO and H₂.

In this process, oxygen may be supplied into the vacuum chamber 70 by the oxygen supplier 120, thereby promoting plasma gasification and increasing the entropy of radicals.

In addition, the temperature within the vacuum chamber 70 may be controlled by the heater 130 and the cooler 140 to activate atomic or ionic energy.

Subsequently, the syngas within the vacuum chamber 70 may be collected and stored through the gas collector 100. Depending on the opening and closing of a gas valve 101, the syngas may be discharged through a separate storage tank or the like.

As described above, the syngas production device using nano-scale pulverization of coal powder according to an embodiment of the present disclosure enables the nano-scale coal powder and gas molecules containing oxygen to be converted into syngas through collisions with high-energy electrons generated from the plasma within the vacuum chamber 70, thereby enabling maximization of syngas production efficiency relative to the feed rate of the coal powder.

In the meantime, the present disclosure is not limited to the embodiments and the accompanying drawings described above. It is apparent to those skilled in the technical field to which the present disclosure pertains that various modifications and applications not illustrated herein may be possible without departing from the technical idea of the present disclosure, and that each component may be substituted with or changed to other equivalent embodiments for broad application.

Therefore, the content relating to modifications and applications of the technical features of the present disclosure should be construed as falling within the technical idea and scope of the present disclosure.

A syngas production device using nano-scale pulverization of coal powder according to an embodiment of the present disclosure is intended to obtain syngas, which is primarily composed of CO and H₂ used as alternative fuels in various industrial fields, by a method in which coal powder is pulverized to an ultrafine size, induced to undergo an implosion, and then gasified in a plasma state through plasma gasification. Thus, the present disclosure is industrially applicable.

What is claimed is:

1. A syngas production device using nano-scale pulverization of coal powder, the syngas production device comprising:
a hopper configured to store and feed coal powder;
a pulverizer configured to pulverize the coal powder, fed from the hopper, to an ultrafine size and feed the resulting ultrafine coal powder;
a plurality of injectors configured to pneumatically convey the ultrafine coal powder, which has been pulverized to the ultrafine size within the pulverizer, and inject the same into a cylindrical header within a vortex chamber;
a distributor installed on a pipeline between the pulverizer and the injectors, and configured to evenly feed the ultrafine coal powder, fed from the pulverizer, to the respective injectors;
a pair of vortex fans configured to be rotated by a motor and generate a swirling airflow within the vortex chamber, thereby enabling nano-scale pulverization of the ultrafine coal powder through collisions and repeated friction at a point where centrifugal and centripetal forces generated by a vortex-induced airflow are in equilibrium;
a vacuum chamber vertically separated from the vortex chamber by a partition wall;
a plurality of spiral branch pipes, each having a first end being fixedly connected in communication with an interior of the header from outside the header and a second end (opposite to the first end) being connected in communication with an interior of the vacuum chamber, thereby inducing an implosion of the resulting nano-scale coal powder to be fed into the vacuum chamber;
a plasma generator configured to form ions and radicals from the nano-scale coal powder and gas within the vacuum chamber to generate a plasma state, and to convert the resulting plasma-state gas into syngas through plasma gasification; and
a gas collector configured to collect and store the syngas within the vacuum chamber.

2. The syngas production device of claim 1, further comprising: an electromagnet configured to magnetically separate and collect pyrite (FeS₂) within the vortex chamber.

3. The syngas production device of claim 1, further comprising:
an oxygen supplier configured to supply oxygen into the vacuum chamber to promote plasma gasification and increase the entropy of radicals;
a heater configured to activate atomic or ionic energy within the vacuum chamber through temperature control; and
a cooler.

4. The syngas production device of claim 1, wherein the pair of vortex fans is rotated in opposite directions, and each vortex fan is mounted in such a configuration that two impellers overlap on a motor shaft of the motor and is installed within the vortex chamber at an oblique angle in a range of 30 to 60 degrees relative to a horizontal plane so that airflows intersect.

5. The syngas production device of claim 1, wherein the branch pipes are arranged all around the header, and each branch pipe is formed as a conical spiral pipe having an inner diameter that gradually decreases from the first end adjacent to the header toward the second end.
